(19) United States
(12) Patent Application Publication
(10) Pub. No.: US 2024/0093072 A1
(43) Pub. Date: Mar. 21, 2024

(54) ONE-COMPONENT TOUGHENED EPOXY ADHESIVES

(71) Applicant: DDP SPECIALTY ELECTRONIC MATERIALS US, LLC, WILMINGTON, DE (US)

(72) Inventors: Felix Koch, Altendorf (CH); Andreas Lutz, Galgenen (CH); Cathy Grossnickel, Freienbach (CH); Jeannine Flueckiger, Freienbach (CH)

(21) Appl. No.: 18/510,150

(22) Filed: Nov. 15, 2023

Related U.S. Application Data
(63) Continuation of application No. 16/640,778, filed on Feb. 21, 2020.
(60) Provisional application No. 62/557,224, filed on Sep. 12, 2017.

(51) Int. Cl. C09J 163/00

(52) U.S. Cl. CPC C09J 163/00

(57) ABSTRACT

One-component epoxy adhesives containing a phosphorus-modified epoxy resin, a toughener and an epoxy resin that is neither rubber-modified nor phosphorus-modified. These adhesives are structural adhesives useful in automotive applications. They exhibit particularly good corrosion resistance.

This application claims priority to U.S. patent application Ser. No. 16/640,778, filed on Feb. 21, 2020, which claimed priority to International Application No. PCT/US18/043022, filed on Jul. 20, 2018, which claimed priority to U.S. Patent Application Ser. No. 62/557,224, filed on Sep. 12, 2017. All parent applications are incorporated herein by reference in their entireties.

This invention relates to one-component toughened epoxy adhesives.

Structural adhesives are used to bond body structures in vehicles. One-part epoxy adhesives are used predominantly for this purpose in vehicular manufacturing operations.

Epoxy adhesives exhibit very strong initial adhesion to metals. The long service life of vehicles demands that the adhesive maintains the bond for many years. During this time, the vehicle and the adhesive are exposed to large changes in temperature as well as to water, oils, salts, dirt and other contaminants. These conditions weaken the adhesive. Salt in particular is highly corrosive to the adhesives.

What is desired is a one-part structural epoxy adhesive that bonds strongly to metals and other substrates, and which exhibits good corrosion resistance.

This invention is a one-component epoxy adhesive comprising in admixture A) a non-rubber-modified, non-phosphorous-modified epoxy resin or mixture thereof, the non-rubber-modified, non-phosphorous-modified epoxy resin or mixture thereof being a liquid at 23° C., B) one or more reactive urethane group- and/or urea group-containing polymers having a number average molecular weight of up to 35,000, at least one polyether and/or diene rubber segment having a weight of at least 1000 atomic mass units, and capped isocyanate groups, C) at least one epoxy curing catalyst, D) a curing agent and E) 3.5 to 50 weight-%, based on the weight of the adhesive, of an epoxy-containing adduct of an epoxy resin and a phosphorus acid, said one-component toughened epoxy adhesive containing no more than 2 parts by weight of a plasticizer per part by weight of component B) and containing no more than 7 weight percent of core-shell rubber particles, and wherein the adhesive exhibits a curing temperature of at least 60° C.

The invention is also method for bonding two substrates, comprising forming a layer of the foregoing adhesive at a bondline between two substrates to form an assembly, and then curing adhesive layer at the bondline by heating to a temperature of at least 130° C. to form a cured adhesive bonded to the two substrates at the bondline.

The invention is also a method for forming a bonded and coated assembly, comprising 1) forming a layer of the foregoing adhesive at a bondline between a first substrate and a second substrate to form an assembly that includes the first and second substrates each in contact with the adhesive composition at the bondline; then
2) immersing the assembly into a coating bath to form a layer of an uncured coating on at least a portion of an exposed surface of the assembly; and
3) heating the coated assembly from step 2) to a temperature of at least 140° C. to cure the adhesive to form a cured adhesive bonded to the substrates at the bondline and simultaneously cure the coating layer.

The adhesive of the invention bonds very strongly to metals and other substrates, and exhibits remarkable retention of its adhesive properties even after exposure to a corrosive environment.

The adhesive contains at least one epoxy resin (Component A) that is non-rubber-modified and is non-phosphorus-modified. By “non-rubber-modified”, it is meant that, prior to curing, the epoxy resin is not chemically bonded to a rubber as described below.

By “non-phosphorus-modified”, it is meant that, prior to curing the adhesive, the epoxy resin has not been reacted with phosphoric acid, a polyphosphoric acid, a phosphoric or polyphosphoric acid salt, or a phosphoric acid or polyphosphoric acid ester, to introduce one or more

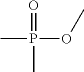

moieties into the resin structure.

If only a single non-rubber-modified, non-phosphorous-modified epoxy resin is present, it is a liquid at 23° C. If two or more non-rubber-modified, non-phosphorous-modified epoxy resins are present, the mixture thereof is a liquid at 23° C., although individual epoxy resins within the mixture may be by themselves solids at 23° C.

A wide range of epoxy resins can be used as a non-rubber-modified, non-phosphorous-modified epoxy resin, including those described at column 2 line 66 to column 4 line 24 of U.S. Pat. No. 4,734,332, incorporated herein by reference. The epoxy resin should have an average of at least 1.8, preferably at least 2.0, epoxide groups per molecule. The epoxy equivalent weight may be, for example, 75 to 350, 140 to 250 and or 150 to 225. If a mixture of non-rubber-modified, non-phosphorus-modified epoxy resins is present, the mixture should have an average epoxy functionality of at least 1.8, preferably at least 2.0, and an epoxy equivalent weight as in the previous sentence, and more preferably each epoxy resin in the mixture has such an epoxy functionality and epoxy equivalent weight.

Suitable non-rubber-modified, non-phosphorus-modified epoxy resins include diglycidyl ethers of polyhydric phenol compounds such as resorcinol, catechol, hydroquinone, biphenol, bisphenol A, bisphenol AP (1,1-bis(4-hydroxylphenyl)-1-phenyl ethane), bisphenol F, bisphenol K and tetramethylbiphenol; diglycidyl ethers of aliphatic glycols such as the diglycidyl ethers of C2-24 alkylene glycols; polyglycidyl ethers of phenol-formaldehyde novolac resins (epoxy novolac resins), alkyl substituted phenol-formaldehyde resins, phenol-hydroxybenzaldehyde resins, cresol-hydroxybenzaldehyde resins, dicyclopentadiene-phenol resins and dicyclopentadiene-substituted phenol resins; and any combination of any two or more thereof.

Suitable epoxy resins include diglycidyl ethers of bisphenol A resins such as are sold by Olin Corporation under the designations D.E.R.® 330, D.E.R.® 331, D.E.R.® 332, D.E.R.® 383, D.E.R. 661 and D.E.R.® 662 resins.

Epoxy novolac resins can be used. Such resins are available commercially as D.E.N.® 354, D.E.N.® 431, D.E.N.® 438 and D.E.N.® 439 from Olin Corporation.

Other suitable non-rubber-modified, non-phosphorus-modified epoxy resins are cycloaliphatic epoxides. A cycloaliphatic epoxide includes a saturated carbon ring having an epoxy oxygen bonded to two vicinal atoms in the carbon ring, as illustrated by the following structure III:

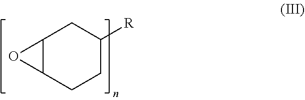

wherein R is an aliphatic, cycloaliphatic and/or aromatic group and n is a number from 1 to 10, preferably from 2 to 4. When n is 1, the cycloaliphatic epoxide is a monoepoxide. Di- or polyepoxides are formed when n is 2 or more. Mixtures of mono-, di- and/or polyepoxides can be used. Cycloaliphatic epoxy resins as described in U.S. Pat. No. 3,686,359, incorporated herein by reference, may be used in the present invention. Cycloaliphatic epoxy resins of particular interest are (3,4-epoxycyclohexyl-methyl)-3,4-epoxy-cyclohexane carboxylate, bis-(3,4-epoxycyclohexyl) adipate, vinylcyclohexene monoxide and mixtures thereof.

Other suitable epoxy resins include oxazolidone-containing compounds as described in U.S. Pat. No. 5,112,932. In addition, an advanced epoxy-isocyanate copolymer such as those sold commercially as D.E.R. 592 and D.E.R. 6508 (Dow Chemical) can be used.

In some embodiments, the non-rubber-modified, non-phosphorus-modified epoxy resin includes a first diglycidyl ether of a bisphenol that has an epoxy equivalent weight of up to 225 and a second diglycidyl ether of a bisphenol that has an epoxy equivalent weight of greater than 225 to 750. The first diglycidyl bisphenol ether may be by itself a liquid at 23° C. and the second may be by itself a solid at 23° C., provided the mixture is a liquid at that temperature. Each of these may be diglycidyl ethers of bisphenol-A or bisphenol-F, which may be partially advanced to obtain epoxy equivalent weights as indicated.

Component B) is one or more reactive urethane group- and/or urea group-containing polymers having a number average molecular weight of up to 35,000, at least one polyether or diene rubber segment having a weight of at least 1000 atomic mass units, and capped isocyanate groups. Useful such materials are described, for example, in U.S. Pat. Nos. 5,202,390, 5,278,257, WO 2005/118734, WO 2007/003650, WO2012/091842, U. S. Published Patent Application No. 2005/0070634, U. S. Published Patent Application No. 2005/0209401, U. S. Published Patent Application 2006/0276601, EP-A-0 308 664, EP 1 498 441A, EP-A 1 728 825, EP-A 1 896 517, EP-A 1 916 269, EP-A 1 916 270, EP-A 1 916 272 and EP-A-1 916 285.

Component B) materials are conveniently made in a process that includes the steps of forming an isocyanate-terminated polyether and/or diene rubber and capping the isocyanate groups with a phenol or polyphenol. The isocyanate-terminated polyether and/or diene rubber is conveniently made by reacting a hydroxyl- or amine-terminated polyether, a hydroxyl- or amine-terminated diene rubber, or a mixture of both, with an excess of a polyisocyanate to produce adducts that have urethane or urea groups and terminal isocyanate groups. If desired, the isocyanate-terminated polyether and/or diene rubber can be chain-extended and/or branched simultaneously with or prior to performing the capping reaction.

The isocyanate-terminated polyether or isocyanate-terminated diene polymer can have aromatic or aliphatic isocyanate groups. The polyisocyanate used in preparing this material preferably has at least 2 isocyanate groups per molecule and a molecular weight of up to 300 g/mol. It may be an aromatic polyisocyanate such toluene diamine or 2,4′- and/or 4,4′-diphenylmethane diamine, or an aliphatic polyisocyanate such as isophorone diisocyanate, 1,6-hexamethylene diisocyanate, hydrogenated toluene diisocyanate, hydrogenated methylene diphenylisocyanate (H₁₂MDI), and the like.

The hydroxyl- or amine-terminated polyether may be a polymer or copolymer of one or more of tetrahydrofuran (tetramethylene oxide), 1,2-butylene oxide, 2,3-butylene oxide, 1,2-propylene oxide and ethylene oxide, with polymers or copolymers of at least 70 weight-%, based on the total weight of the polymer or copolymer, of tetrahydrofuran, 1,2-butylene oxide, 2,3-butylene oxide and 1,2-propylene oxide being preferred. Polymers of at least 80 weight-% tetrahydrofuran, based on the total weight of the polymer or copolymer, are especially preferred. The starting polyether preferably has 2 to 3, more preferably 2, hydroxyl and/or primary or secondary amino groups per molecule. The starting polyether preferably has a number average molecular weight of 900 to 8000, more preferably 1500 to 6000 or 1500 to 4000.

The hydroxyl- or amine-terminated diene polymer preferably has a glass transition temperature, prior to reaction with the polyisocyanate, of no greater than −20° C. and preferably no greater than −40° C. The diene polymer is a liquid homopolymer or copolymer of a conjugated diene, especially a diene/nitrile copolymer.

The conjugated diene is preferably butadiene or isoprene, with butadiene being especially preferred. The preferred nitrile monomer is acrylonitrile. Preferred copolymers are butadiene-acrylonitrile copolymers. The rubbers preferably contain, in the aggregate, no more than 30 weight percent polymerized unsaturated nitrile monomer, and preferably no more than about 26 weight percent polymerized nitrile monomer. The hydroxyl- or amine-terminated diene polymer preferably has 1.8 to 4, more preferably 2 to 3, hydroxyl and/or primary or secondary amino groups per molecule. The starting diene polymer preferably has a number average molecular weight of 900 to 8000, more preferably 1500 to 6000 and still more preferably 2000 to 3000.

The isocyanate-terminated polymer is conveniently prepared by the reaction of the foregoing polyisocyanate with the hydroxyl- or amine-terminated polyether and/or hydroxyl- or amine-terminated diene rubber, at a ratio of at least 1.5 equivalents, preferably 1.8 to 2.5 equivalents or 1.9 to 2.2 equivalents, of polyisocyanate per equivalent of hydroxyl and/or primary or secondary amino groups on the starting polyether or diene rubber.

The reaction to form the isocyanate-terminated polymers can be performed by combining the starting polyether and/or diene rubber with the polyisocyanate and heating to 60 to 120° C., optionally in the presence of a catalyst for the reaction of isocyanate groups with the isocyanate-reactive groups of the polyether or diene polymer. The reaction is continued until the isocyanate content is reduced to a constant value or to a target value, or until the amino- and or hydroxyl groups of the starting polyether or diene polymer are consumed.

If desired, branching can be performed by adding a branching agent into the reaction between the starting polyether or diene polymer and the polyisocyanate, or in a subsequent step. The branching agent, for purposes of this invention, is a polyol or polyamine compound having a molecular weight of up to 599, preferably from 50 to 500, and at least three hydroxyl, primary amino and/or secondary amino groups per molecule. If used at all, branching agents generally constitute no more than 10%, preferably no more than 5% and still more preferably no more than 2% of the combined weight of the branching agent and the starting polyether or diene polymer. Examples of branching agents include polyols such as trimethylolpropane, glycerin, trimethylolethane, ethylene glycol, diethylene glycol, propylene glycol, dipropylene glycol, sucrose, sorbitol, pentaerythritol, triethanolamine, diethanolamine and the like, as well as alkoxylates thereof having a number average molecular weight of up to 599, especially up to 500.

Chain extension can be performed if desired by i) incorporating a chain extender into the reaction which forms the isocyanate-terminated polyether and/or diene polymer or ii) reacting the isocyanate-terminated polyether and/or diene polymer with a chain extender before or while performing the capping step. Chain extenders include polyol or polyamine compounds having a molecular weight of up to 749. preferably from 50 to 500, and two hydroxyl, primary amino and/or secondary amino groups per molecule. Examples of suitable chain extenders include aliphatic diols such as ethylene glycol, diethylene glycol, triethylene glycol, propylene glycol, dipropylene glycol, tripropylene glycol, 1,4-butanediol, 1,6-hexane diol, cyclohexanedimethanol and the like; aliphatic or aromatic diamines such as ethylene diamine, piperazine, aminoethylpiperazine, phenylene diamine, diethyltoluenediamine and the like, and compounds having two phenolic hydroxyl groups such resorcinol, catechol, hydroquinone, bisphenol, bisphenol A, bisphenol AP (1,1-bis(4-hydroxylphenyl)-1-phenyl ethane), bisphenol F, bisphenol K, bisphenol M, tetramethylbiphenol and o,o′-diallyl-bisphenol A, and the like. Among these, the compounds having two phenolic hydroxyl groups are preferred.

The isocyanate groups of the isocyanate-terminated polyether or diene polymer are capped by reaction with a capping agent. Suitable capping agents are described, for example, in WO 2017/044359, incorporated herein by reference, and include various mono- and polyphenol compounds as described more below, as well as various amine compounds, benzyl alcohol, hydroxy-functional acrylate or methacrylate compounds, thiol compounds, alkyl amide compounds having at least one amine hydrogen such as acetamide, and ketoxime compounds.

In some embodiments, at least 90% of the isocyanate groups, more preferably at least 95% of the isocyanate groups, are capped with a monophenol or polyphenol. Examples of monophenols include phenol, alkyl phenols that contain one or more alkyl groups that each may contain from 1 to 30 carbon atoms, a halogenated phenol, cardanol, or naphthol. Suitable polyphenols contain two or more, preferably two, phenolic hydroxyl groups per molecule and include resorcinol, catechol, hydroquinone, biphenol, bisphenol A, bisphenol AP (1,1-bis(4-hydroxylphenyl)-1-phenyl ethane), bisphenol F, bisphenol K, bisphenol M, tetramethylbiphenol and o,o′-diallyl-bisphenol A, as well as halogenated derivatives thereof. In such embodiments, up to 10%, preferably at most 5%, of the isocyanate groups may be capped with other capping agents such as mentioned above.

The capping reaction can be performed under the general conditions described already, i.e., by combining the materials in the stated ratios and allowing them to react at room temperature or an elevated temperature such as 60 to 120° C., optionally in the presence of a catalyst for the reaction of isocyanate groups with the isocyanate-reactive groups of the capping agent. The reaction is continued until the isocyanate content is reduced to a constant value, which is preferably less than 0.1% by weight. Fewer than 3%, preferably fewer than 1%, of the isocyanate groups may remain uncapped.

The capping reaction can be performed at the same time the isocyanate-terminated polyether and/or diene polymer is formed, or as a separate capping step.

The resulting Component B) material suitably has a number average molecular weight of at least 3000, preferably at least 4,000, to about 35,000, preferably to about 20,000 and more preferably to about 15,000, as measured by GPC, taking into account only those peaks that represent molecular weights of 1000 or more.

The polydispersity (ratio of weight average molecular weight to number average molecular weight) of Component B is suitably from about 1 to about 4, preferably from about 1.5 to 2.5.

The epoxy curing catalyst (Component C) is one or more materials that catalyze the reaction of the epoxy resin(s) with the curing agent. It is preferably encapsulated or otherwise a latent type that becomes active only upon exposure to elevated temperatures. Among preferred epoxy catalysts are ureas such as p-chlorophenyl-N,N-dimethylurea (Monuron), 3-phenyl-1,1-dimethylurea (Phenuron), 3,4-dichlorophenyl-N,N-dimethylurea (Diuron), N-(3-chloro-4-methylphenyl)-N′,N′-dimethylurea (Chlortoluron), tert-acryl- or alkylene amines like benzyldimethylamine, 2,4,6-tris(dimethylaminomethyl)phenol, piperidine or derivatives thereof, various aliphatic urea compounds such as are described in EP 1 916 272; C1-C12 alkylene imidazole or N-arylimidazoles, such as 2-ethyl-2-methylimidazol, or N-butylimidazol and 6-caprolactam. 2,4,6-tris(dimethylaminomethyl)phenol integrated into a poly(p-vinylphenol) matrix (as described in European patent EP 0 197 892), or 2,4,6-tris(dimethylaminomethyl)phenol integrated into a novolac resin, including those described in U.S. Pat. No. 4,701,378, are suitable.

The curing agent (Component D) is selected together with Component C such that the adhesive exhibits a curing temperature of at least 60° C. The curing temperature preferably is at least 80° C., and may be at least 100° C., at least 120° C., at least 130° C. or at least 140° C. It may be as high as, for example, 180° C. The “curing temperature” refers to the lowest temperature at which the structural adhesive achieves at least 30% of its lap shear strength (DIN ISO 1465) at full cure within 2 hours. The lap shear strength at “full cure” is measured on a sample that has been cured for 30 minutes at 180° C., which conditions represent “full cure” conditions. Clean (degreased) 1.2 mm HC420LAD+Z100 galvanized steel substrates, a bond area of 10×25 mm and an adhesive layer thickness of 0.3 mm are suitable parameters for performing this evaluation.

The curing agent (Component D) is a compound that reacts with at least two epoxy groups to form a linkage between them. Suitable curing agents include materials such as boron trichloride/amine and boron trifluoride/amine complexes, dicyandiamide, melamine, diallylmelamine, guanamines such as dicyandiamide, methyl guanidine, dimethyl guanidine, trimethyl guanidine, tetramethyl guanidine, methylisobiguanidine, dimethylisobiguanidine, tetramethylisobiguandidine, heptamethylisobiguanidine, hexamethylisobiguanidine, acetoguanamine and benzoguanamine, aminotriazoles such as 3-amino-1,2,4-triazole, hydrazides such as adipic dihydrazide, stearic dihydrazide, isophthalic dihydrazide, semicarbazide, cyanoacetamide, and aromatic polyamines such as diaminodiphenylsulphones. The use of dicyandiamide, isophthalic acid dihydrazide, adipic acid dihydrazide and/or 4,4′-diaminodiphenylsulphone is particularly preferred.

Component E) is one or more epoxy-containing adducts of an epoxy resin and a phosphorus acid or salt thereof.

Such an adduct is sometimes referred to herein as a “phosphorus-modified” epoxy resin. Such adducts are described, for example, in JP 558-063758A.

The epoxy resin used to form the adduct can be any as described above. Preferred epoxy resins are polyglycidyl ethers of polyphenol compounds having an epoxy equivalent weight of 150 to 750, preferably 150 to 225.

For purposes of this invention, a phosphorus acid includes at least one

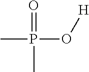

moiety, and includes, for example, phosphoric, phosphonic and phosphinic acids and polyphosphoric acids. A salt thereof has at least one —P—O·M⁺ moiety where M represents a cation. The phosphorus acid may be a partial ester such as a partial alkyl ester (the alkyl group preferably having up to 6 carbon atoms), provided that one or more —P—O—H or —P—O·M⁺ moieties are present.

The epoxy resin and phosphorus acid are reacted at proportions such that an excess of epoxy groups over P—O—H and/or —P—O·M⁺ moieties are provided. It is generally desirable to provide 0.05 to 0.4 equivalents of P—O—H and/or —P—O·M⁺ moieties per equivalent of epoxy groups provided by the epoxy resin(s). The reaction can be performed, for example, at a temperature of 50 to 130° C.

The resulting adduct may have an epoxy equivalent weight at least 10% greater than that of the starting epoxy resin(s). The epoxy equivalent weight may be, for example, 190 to 1000, 200 to 500 or 210 to 350.

Phosphorus-modified epoxy resins such as those sold by Asahi Denka Kogyo KK under the product designations EP 49-10N and EP 49-10P2 are suitable.

Component A) may constitute at least 20%, at least 30% or at least 40% of the total weight of the adhesive, and may constitute up to 80%, up to 70% or up to 60% thereof.

Component B) may constitute at least 0.5%, at least 2%, at least 5%, at least 10% or at least 15% of the total weight of the adhesive, and may constitute up to 40%, up to 30% or up to 25% thereof.

Component C) may constitute at least 0.1 percent, at least 0.25 percent or at least 0.5 percent of the total weight of components A-E, and may constitute, for example, up to 5 percent, up to 3 percent or up to 2 percent of the total weight of components A-E.

Component D) is present in an amount sufficient to cure the composition. Typically, enough of the curing agent is provided to consume at least 80% of the epoxide groups present in the composition. A large excess over that amount needed to consume all of the epoxide groups is generally not needed. Preferably, the curing agent constitutes at least about 1.5 weight percent of the adhesive, more preferably at least about 2.5 weight percent and even more preferably at least 3.0 weight percent. The curing agent preferably may constitute up to about 15 weight percent of the adhesive, up to about 10 weight percent thereof, up to about 8 weight percent, up to about 7 weight percent thereof or up to about 5 weight percent thereof.

Component E) may constitute at least 3.5%, at least 4%, at least 5% or at least 6% of the total weight of the adhesive and may constitute up to 50%, up to 25%, up to 15%, up to 12% or up to 10% of the total weight of the adhesive.

The weight of components A-E may constitute, for example, 30 to 100%, 50 to 100%, 50 to 90% or 50 to 85% of the total weight of the adhesive. If components A-D constitute less than 100% of the total weight of the adhesive, the adhesive will also contain one or more optional ingredients.

Among the optional ingredients are one or more rubbers (different from Component B). These include, for example, a rubber-modified epoxy resin, i.e., a compound having at least two epoxide groups separated by an aliphatic chain of at least 300 g/mol, preferably at least 500 g/mol. The aliphatic chain may be, for example, an alkylene group; an alkenyl group; a diene polymer or copolymer; or a polyether such as a polypropylene oxide), a poly(ethylene oxide) or a copolymer of propylene oxide and ethylene oxide. Other rubber-modified epoxy resins include epoxidized fatty acids (which may be dimerized or oligomerized), and elastomeric polyesters that are modified to contain epoxy groups. The rubber-modified epoxy resin may have, prior to curing, a glass transition temperature of −20° C. or lower, preferably −30° C. or lower.

The optional rubber may include core-shell rubber particles provided that if they are present at all, the core shell rubber particles constitute at most 7 percent of the total weight of the adhesive. Preferably the core-shell rubbers constitute no more than 5%, no more than 2.5% or no more than 1% of the total weight of the adhesive, and may be absent from the adhesive.

The adhesive may contain one or more particulate fillers. The fillers are solids at the temperatures reached in the curing reaction. These fillers perform several functions, such as (1) modifying the rheology of the adhesive in a desirable way, (2) reducing overall cost per unit weight, (3) absorbing moisture or oils from the adhesive or from a substrate to which it is applied, and/or (4) promoting cohesive, rather than adhesive, failure. Examples of suitable mineral fillers include calcium carbonate, calcium oxide, talc, carbon black, textile fibers, glass particles or fibers, aramid pulp, boron fibers, carbon fibers, mineral silicates, mica, powdered quartz, hydrated aluminum oxide, bentonite, wollastonite, kaolin, fumed silica, silica aerogel, polyurea compounds, polyamide compounds, metal powders such as aluminum powder or iron powder and expandable microballoons. A mixture of filler that includes at least fumed silica and calcium oxide, and which may further include calcium carbonate, kaolin and/or wollastonite, can be used. Particulate fillers may constitute, for example, at least 5, at least 10 or at least 12% of the total weight of the adhesive, and may constitute up 35%, up to 30%, up to 25% or up to 20% thereof. If the mineral fillers include fumed silica, the adhesive may contain up to 10% by weight, preferably 1 to 6% by weight of fumed silica.

All or part of the mineral filler may be in the form of fibers having a diameter of 1 to 50 μm (D50, as measured by microscopy) and an aspect ratio of 6 to 20. The diameter of the fibers may be 2 to 30 μm or 2 to 16 μm, and the aspect ratio may be 8 to 40 or 8 to 20. The diameter of the fiber is taken as that of a circle having the same cross-sectional area as the fiber. The aspect ratio of the fibers may be 6 or more, such as 6 to 40, 6 to 25, 8 to 20 or 8 to 15.

Alternatively, all or part of the mineral filler may be in the form of low aspect ratio particles having an aspect ratio of 5 or less, especially 2 or less, and a longest dimension of up to 100 μm, preferably up to 25 μm.

Glass microballoons having an average particle size of up to 200 microns and density of up to 0.4 g/cc may be present in the adhesive of the invention. If present, these can be used in amounts of up to 5% of the total weight of the adhesive, and more preferably up to 2% or up to 1% thereof. Suitable microballoons include 3M® Glass Bubbles K25, from 3M Corporation. Accordingly, in some embodiment, glass microballons are present in an amount of no greater than 0.5% or no greater than 0.25% of the total weight of the adhesive, and may be absent.

A monomeric or oligomeric, addition polymerizable, ethylenically unsaturated material is optionally present in the adhesive composition. This material should have a molecular weight of less than about 1500. This material may be, for example, an acrylate or methacrylate compound, an unsaturated polyester, a vinyl ester resin, or an epoxy adduct of an unsaturated polyester resin. A free radical initiator can be included in the adhesive composition as well, in order to provide a source of free radicals to polymerize this material. The inclusion of an ethylenically unsaturated material of this type provides the possibility of effecting a partial cure of the adhesive through selective polymerization of the ethylenic unsaturation.

The adhesive can further contain other additives such as dimerized fatty acids, reactive diluents, pigments and dyes, fire-retarding agents, thixotropic agents, expanding agents, flow control agents, adhesion promoters and antioxidants. Suitable expanding agents include both physical and chemical type agents. The adhesive may also contain a thermoplastic powder such as polyvinylbutyral or a polyester polyol, as described in WO 2005/118734.

The adhesive preferably contains no more than 2 parts by weight of a plasticizer per part by weight of Component B). It may contain no more than 1 part, no more than 0.5 part or no more than 0.1 part of a plasticizer on the same basis, and may be devoid of a plasticizer. A plasticizer, for purposes of this invention, is a material that a) is a room temperature (23° C.) liquid in which component A) is soluble at room temperature, b) has a molecular weight of at least 100 g/mol, c) has a boiling temperature of at least 150° C. and d) lacks epoxide groups and epoxide-reactive groups. If a plasticizer is present, it preferably has a boiling temperature of at least 210° C. Examples of plasticizers include alkyl-substituted aromatic hydrocarbons such as alkyl naphthalenes, dialkyl naphthalenes, alkyl benzenes, dialkyl benzenes, and the like; phthalate esters, trimellitate esters, adipate esters, maleate esters, benzoate esters, terephthalate esters, various fatty acid esters, epoxidized vegetable oils, sulfonamides, alkyl citrates, acetylated monogylcerides, tricresyl phosphate, cresyl diphenyl phosphate, isopropylated triphenyl phosphate, 2-ethylhexyl diphenyl phosphate, isodecyl diphenyl phosphate, triphenyl phosphate, tributoxyethyl phosphate, and the like. In particular embodiments, the adhesive is devoid of a carboxylic acid ester plasticizer, a sulfonamide plasticizer and a phosphate ester plasticizer.

The adhesive is a one-component adhesive in which the foregoing components are mixed together prior to being applied and cured. The method of combining the ingredients is not particularly critical, provided that temperatures are low enough that premature curing does not take place. The formulated adhesive can be stored at a temperature of, for example, up to 100° C., up to 80° C., up to 60° C. or up to 40° C. for a period of at least one day prior to being applied and cured.

The foregoing adhesive composition is formed into a layer at a bondline between two substrates to form an assembly, and the adhesive layer is cured at the bondline to form a cured adhesive bonded to each of the two substrates.

The adhesive can be applied to the substrates by any convenient technique. It can be applied cold or be applied warm if desired. It can be applied manually and/or robotically, using for example, a caulking gun, other extrusion apparatus, or jet spraying methods. Once the adhesive composition is applied to the surface of at least one of the substrates, the substrates are contacted such that the adhesive is located at a bondline between the substrates.

After application, the adhesive is cured by heating it to or above its curing temperature. Although lower temperatures can be used in some instances, particularly when longer curing times can be tolerated, it is generally preferable to perform the curing step by heating the adhesive to at least 130° C. The heating temperature may be as high as 220° C. or more, but as an advantage of this invention is the lower curing onset temperature, the curing temperature preferably is up to 200° C., up to 180° C., up to 170° C. or up to 165° C.

The adhesive of the invention can be used to bond a variety of substrates together including wood, metal, coated metal, a metal such as steel, zinc, copper, bronze, magnesium, titanium and/or aluminum, a variety of plastic and filled plastic substrates, fiberglass and the like. In one preferred embodiment, the adhesive is used to bond parts of automobiles together or to bond automotive parts onto automobiles.

The substrates can be different materials. Examples of substrate pairings include pairings of different metals such as steel and aluminum; steel and magnesium; and aluminum and magnesium; pairings of a metal such as steel, magnesium, aluminum or titanium with a polymeric material such as thermoplastic organic polymer or a thermoset organic polymer; and pairing of a metal such as steel aluminum, magnesium or titanium and a fiber composite such as a carbon-fiber composite or a glass fiber composite.

An application of particular interest is bonding of automotive or other vehicular frame components to each other or to other components.

Assembled automotive and other vehicular frame members often are coated with a coating material that requires a bake cure. The coating is typically baked at temperatures that may range from 160° C. to as much as 210° C. In such cases, it is often convenient to apply the adhesive to the frame components, then apply the coating, and cure the adhesive at the same time the coating is baked and cured. Between the steps of applying the adhesive and applying the coating, the assembly may be fastened together to maintain the substrates and adhesive in a fixed position relative to each other until the curing step is performed. Mechanical means can be used as a fastening device. These include, for example, temporary mechanical means such as various types of clamps, bands and the like, which can be removed once the curing step is completed. The mechanical fastening means can be permanent, such as, for example, various types of welds, rivets, screws, and/or crimping methods. Alternatively or in addition, the fastening can be done by spot-curing one or more specific portions of the adhesive composition to form one or more localized adhesive bonds between the substrates while leaving the remainder of the adhesive uncured until a final curing step is performed after the coating is applied.

The cured adhesive may have a Casson plastic viscosity of at least 25 Pa, at least 50 Pa or at least 70 Pa, up to 1000 Pa, up to 700 Pa, up to 400 Pa or up to 200 Pa, at 45° C.

The cured adhesive forms a strong bond to various substrates. A particular advantage of the invention is that the adhesive has excellent resistance to corrosive aging. For purposes of this invention, resistance to corrosive testing is evaluated by lap shear strength testing per DIN EN 1465. Test samples are prepared as set forth in the following examples. The lap shear strength of unaged test samples is measured. Identical test samples are prepared and exposed to 90 cycles of the Volkswagen PV 1210 corrosion aging protocol and their lap shear strength is measured. The adhesive of the invention often exhibits a loss of 40% or less of lap shear strength after the corrosion protocol, compared to the lap shear strength of the unaged samples. In some embodiments, this excellent resistance to corrosive aging is achieved even when the adhesive contains a very small amount (such as 0.75 weight percent or less, based on total adhesive weight) of glass microspheres, or even when it is devoid of glass microspheres.

The cured adhesive in some embodiments exhibits an unaged lap shear strength, measured on test samples prepared as in the following examples, of at least 25 MPa, at least 28 MPa or at least 30 MPa, up to 50 MPa. The lap shear strength after corrosion aging may be at least 16 MPa, at least 17 MPa, at least 18 MPa or at least 20 MPa.

The cured adhesive may have an elastic modulus of at least 800 MPa at least, at least 1500 MPa or at least 1800 MPa. It may exhibit a tensile strength of at least 25 MPa or at least 28 MPa. It may have an elongation at break of at least 2%, at least 4% or at least 6%, up to 40%, up to 20%, up to 15% or up to 10%.

The following examples are provided to illustrate the invention but are not intended to limit the scope thereof. All parts and percentages are by weight unless otherwise indicated. All molecular weights are number averages unless otherwise indicated.

### Examples 1-3 and Comparative Samples A, B and C

One-component adhesive Examples 1-3 and Comparative Samples A-C are prepared by mixing ingredients as indicated in Table 1. All have curing temperatures of at least 100° C.

The Component B material is prepared by mixing 58.8 parts of a 2000 number average molecular weight polytetrahydrofuran diol (PolyTHF 2000 from BASF) with 14.4 parts of a 2800 number average molecular weight hydroxyl-terminated poly(butadiene) (Poly BD R45 HTLO from Cray Valley). This mixture is dried under vacuum at 120° C. and cooled to 60° C. 11.65 parts of hexamethylene diisocyanate are added, followed by 0.06 parts of a tin catalyst, and the ingredients are allowed to react to produce an isocyanate-terminated prepolymer. The prepolymer is then reacted sequentially at 100-105° C. with o,o′-diallylbisphenol A and cardanol to cap the isocyanate groups. The resulting Component B material has a number average molecular weight of 6200 g/mol and a polydispersity of 2.8, as measured by gel permeation chromatography in tetrahydrofuran using universal calibration.

TABLE 1

| | Parts by Weight | | | | | |
|---|---|---|---|---|---|---|
| | Sample Designation | | | | | |
| Ingredient | A* | B* | 1 | C* | 2 | 3 |
| Component A¹ | 42.85 | 39.85 | 37 | 34 | 37.68 | 38.3 |
| Component B | 20 | 20 | 20 | 20 | 20 | 20 |
| Component C² | 0.8 | 0.8 | 0.8 | 0.8 | 0.8 | 0.8 |
| Component D³ | 3.65 | 3.65 | 3.50 | 3.65 | 3.60 | 3.70 |
| Component E⁴ | 0 | 3.0 | 6.0 | 0 | 6.0 | 6.0 |
| Silane Coupling Agent⁵ | 1.2 | 1.2 | 1.2 | 0.8 | 1.2 | 1.2 |
| Fillers⁶ | 28 | 28 | 28 | 28 | 28 | 28 |
| Glass Microspheres | 1.5 | 1.5 | 1.5 | 0.75 | 0.75 | 0 |
| Epoxy-functional diluent⁷ | 2.0 | 2.0 | 2.0 | 2.0 | 2.0 | 2.0 |

¹Liquid mixture of a diglycidyl ether of bisphenol A having an epoxy equivalent weight of about 186 and a diglycidyl ether of bisphenol A resin having an epoxy equivalent weight of about 520. The amount of the latter is 9.5 parts in all cases, with the former constituting the remainder of the indicated weight.
²50/50 by weight mixture of an aliphatic bis urea sold by Emerald Materials as Omicure ™U-35M and a 4,4′-methylene bis (phenyldimethylurea) sold by Emerald Materials as Omicure ™ U-52M.
³Dicyandiamide sold as Amicure CG 120 G by Air Products.
⁴Phosphoric acid-modified diglycidyl ether of bisphenol A, sold by Asahi Denka as EP49-10P2 epoxy resin.
⁵Dynasylan GLYEO from Evonik Industries.
⁶Mixture of fumed silica, calcium oxide, wollastonite, calcium carbonate and colorant.
⁷Monoglycidyl ether of p-tertiarybutyl phenol.

Corrosion resistance is evaluated on each of Comparative Samples A-C and Examples 1-3 by measuring lap shear strength (per DIN EN 1465) on samples that have and have not undergone environmental aging.

Lap shear specimens are prepared using 1.2 mm-thick HC420LAD+Z100 galvanized steel test strips. The test strips are degreased and then re-greased by dip coating them into a solution of 90% heptane and Anticorit PL3802-395 corrosion prevention oil (Fuchs Lubricants UK). The adhesive in each case is applied to one of the strips, and 0.3 mm glass beads are sprinkled on top of the adhesive before overlaying the second strip. The bond area is 10×25 mm with a thickness of 0.3 mm as determined by the glass beads. The assembled test specimens are held together with metal clips and baked at 150° C. for 45 minutes. The specimens are then dipped into an E-coat bath and cured for 30 minutes at 180° C.

In all cases, lap shear specimens are prepared in multiples. Fresh samples are tested for lap shear strength after equilibrating to 23° C. Aged samples are tested after undergoing 90 cycles of the Volkswagen PV 1210 protocol and being equilibrated to 23° C.

Impact peel strength is evaluated according to ISO 11343 on samples that have not undergone environmental aging. The adhesives are used to bond DX 56+Z (EN 10 346) low carbon galvanized steel to DC 04+ZE (EN 10 152) electrogalvanized steel.

The substrates are degreased and re-greased prior to assembling the test specimens as per the lap shear strips. The adhesive composition is applied to one metal strip, with spacers to adjust the adhesive layer thickness to 0.2 mm. The second metal strip is then applied to the adhesive layer. Bond area is 20×30 mm. The test specimens are held together with metal clips and cured for 30 minutes at 180° C. The impact load is 90 J at drop weight speed of 2 m/s. Impact peel strength is reported as average impact load at plateau using a Zwick-Roell impact tester.

The elastic modulus, tensile strength and elongation of the cured adhesives are measured according to DIN ISO 527-1, after curing the adhesive for 30 min at 180° C. in a hot press between metal plates.

Plastic viscosity at 45° C. is measured on a Bohlin CS-50 Rheometer, under conditions C/P 20 and up/down 0.1-20s⁻¹, and is calculated using the Casson model.

Results of the foregoing testing are as indicated in Table 2.

TABLE 2

| | Sample Designation | | | | | |
|---|---|---|---|---|---|---|
| Test | A* | B* | 1 | C* | 2 | 3 |
| % Component E | 0 | 3 | 6 | 0 | 6 | 6 |

Lap Shear Strength (MPa)

| | | | | | | |
|---|---|---|---|---|---|---|
| Initial | 29.1 | 29.1 | 28.9 | 35.3 | 32.2 | 32.2 |
| After corrosion aging | 14.4 | 12.3 | 17.3 | 14.2 | 20.6 | 20.9 |
| Loss after aging (%) | 50 | 57 | 40 | 60 | 36 | 35 |
| Impact Peel Resistance | 34.0 | 34.1 | 33.6 | 35.0 | 35.4 | 35.7 |
| (N/mm) | | | | | | |
| Elastic Modulus (MPa) | 1940 | ND | 1837 | 2032 | 1800 | ND |
| Tensile Strength (MPa) | 28.7 | ND | 28.1 | 32.9 | 28.3 | ND |
| Elongation at break (%) | 6.0 | ND | 7.2 | 7.5 | 7.5 | ND |
| Plastic Viscosity, | 74 | 75 | 89 | 77 | 67 | 66 |
| 45° C. (Pa) | | | | | | |

Comparative Sample A loses 50% of its lap shear strength after corrosive aging. Comparative Sample B, which contains 3% of the phosphorus-modified epoxy resin, performs even more poorly, losing 57% of its lap shear strength. The presence of 3% of the phosphorus-modified epoxy resin surprisingly does not increase initial lap shear strength, as seen by comparing the values for Comparative Samples A and B.

Example 1 exhibits essentially the same initial lap shear strength and impact peel resistance as do Comparative Samples A and B, again confirming that the presence of the phosphorus-modified epoxy resin at these levels has negligible effect on adhesive strength. However, the corrosion-aged sample has a lap shear strength that is 20% greater than Comparative Sample A and 40% greater than Comparative Sample B. These results demonstrate a large improvement in resistance to corrosive aging.

The results for Comparative Sample C and Examples 2 and 3 show the same pattern. Comparative Sample C loses 60% of its initial lap shear strength after corrosive aging, compared to only about 35% for each of Examples 2 and 3. The corrosion-aged Examples 2 and 3 have lap shear strengths about 45% greater than Comparative Sample C. This is achieved even though, as before, the presence of the phosphorus-modified epoxy resin surprisingly has no significant positive impact on the initial lap shear results.

Examples 2 and 3 also are notable because of their content (or absence in the case of Example 3) of hollow glass microspheres. Hollow glass microspheres are known to impart corrosion resistance to structural adhesives. This is reflected in the greater loss of lap shear strength after corrosion testing of Comparative Sample C vs. Comparative Sample A. In those cases, removing half of the hollow glass microspheres (Comparative Sample C) results in a loss of 60% of initial strength vs. only a 50% loss for Comparative Sample A). Example 2 demonstrates much less loss of lap shear strength compared to both Comparative Samples A and C. The presence of 6% of the phosphorus-modified epoxy resin overcomes the negative effect of reducing the amount of microspheres. Example 3 demonstrates that this advantage is obtained even in the absence of hollow glass microspheres.

What is claimed is:

1. A one component toughened epoxy adhesive comprising
A) an epoxy resin selected from a non-rubber-modified epoxy resin, non-phosphorous-modified epoxy resin or a mixture thereof, the epoxy resin being a liquid at 23° C.;
B) a polymer having a number average molecular weight of up to 35,000, wherein the polymer contains one or more reactive groups being a urethane group or a urea group, or a mixture thereof, wherein the polymer has a) at least one polyether and/or diene rubber segment having a weight of at least 1000 atomic mass units and b) capped isocyanate groups;
C) at least one epoxy curing catalyst;
D) a curing agent; and
E) 5 to 50 wt. %, based on the weight of the adhesive, of an epoxy containing adduct of an epoxy resin and a phosphorus acid;
wherein said one component toughened epoxy adhesive further contains no more than 2 parts by weight of a plasticizer per part by weight of component B) and contains no more than 7 weight percent of core shell rubber particles; and
wherein the adhesive exhibits a curing temperature of at least 60° C.

2. The one-component epoxy adhesive of claim 1, wherein component E is a reaction product of at least one epoxy resin and a phosphorus acid at a ratio of 0.05 to 0.4 equivalents of P—O—H and/or —P—O·M⁺ moieties per equivalent of epoxy groups provided by the at least one epoxy resin.

3. The one-component epoxy adhesive of claim 1, wherein Component E is a reaction product of a diglycidyl ether of a polyphenol having an epoxy equivalent weight of 150-225 and the phosphorus acid.

4. The one-component epoxy adhesive of claim 1 comprising 5 to 15 wt. % of component E, based on the weight of the adhesive.

5. The one-component epoxy adhesive of claim 1, wherein component A includes at least one diglycidyl ether of a bisphenol.

6. The one-component epoxy adhesive of claim 1, wherein component A includes a first diglycidyl ether of a bisphenol that has an epoxy equivalent weight of up to 225 and a second diglycidyl ether of a bisphenol that has an epoxy equivalent weight of greater than 225 and less than or equal to 750.

7. The one-component epoxy adhesive of claim 1, wherein the capped isocyanate groups are capped with a monophenol or polyphenol.

8. The one-component epoxy adhesive of claim 1, wherein component D includes dicyandiamide.

9. The one-component epoxy adhesive of claim 1, wherein component C includes a urea compound.

10. The one-component epoxy adhesive of claim 1 comprising 0 to 0.75 wt. % of glass microspheres, based on the weight of the one-component epoxy adhesive.

11. The one-component epoxy adhesive of claim 4 comprising about 6 wt. % of component E, based on the weight of the adhesive.
